(19) United States
(12) Patent Application Publication
(10) Pub. No.: US 2005/0115944 A1
(43) Pub. Date: Jun. 2, 2005

(54) Method and apparatus for a food delivery container

(76) Inventors: Boris E. Goldman, Newton, CT (US); Michael E. Portnoy, Newtown, CT (US)

Correspondence Address: James J. Merrick;Cantor Colburn LLP, 55 Griffin Road South, Bloomfield, CT, 06002, US

(21) Appl. No.: 11/007,059

(22) Filed: Dec. 8, 2004

Related U.S. Application Data
(63) Continuation-in-part of application No. 09/910,203, filed on Jul. 20, 2001, now abandoned.

(51) Int. Cl. F27D 11/00

(52) U.S. Cl. 219/387

(57) ABSTRACT

A food transportation container which will maintain food in a fresh, hot and undeteriorated condition during delivery of the food from its point of origin to its destination, while being disposable, lightweight, thin, easy to use, and deformable enough to allow storage in a small space (i.e. consumer's pocket). The container will not impart undesirable taste to its contents.

### CROSS REFERENCE TO RELATED APPLICATIONS

This is a continuation-in-part of U.S. patent application Ser. No. 09/910,203, entitled “Method and Apparatus for a Food Delivery Container”, filed on Jul. 20, 2001 and the contents of which are incorporated herewith in their entirety. This application is also related to U.S. patent application Ser. No. 10/439,220, entitled “Method and Apparatus for a Food Delivery Container”, filed on May 15, 2003, which is also a continuation-in-part of U.S. patent application Ser. No. 09/910,203, entitled “Method and Apparatus for a Food Delivery Container”, filed on Jul. 20, 2001 and the contents of which are incorporated herewith in their entirety.

### BACKGROUND

It is customary for pizzas to be prepared for take-out by customers, or for delivery to the houses of persons who place orders for pizzas by telephone. One format for packaging pizzas in such circumstances is to place the pizza in a single-walled, paper-board box that folds up from a flat paper-board blank. Such boxes customarily enclose the pizza with a lid. The conventional means of packaging Chinese food, bakery products, or the like, other than pizza, for take out or for home delivery are also a cardboard box of square or rectangular shape.

Boxes of this type provide only a moderate degree of heat retention for the pizza during delivery. If the boxes are unvented, an extended delivery period can result in a pizza/food that is both cool and soggy.

The standard cardboard pizza box also has a number of drawbacks. For one thing, cardboard containers have a low insulation coefficient. Furthermore, during transportation, the pizza crust loses the rigid, crispy texture it had only 30 minutes earlier. The explanation for this is simple. As the steamy hot pizza is removed from the oven and placed in the box, it continues to give off moisture and heat until it has cooled. The standard cardboard box, though not perfectly airtight, retains substantially all of the moisture given off by the pizza. In essence, the pizza sits in a steam sauna during delivery. The final result is that the driest portion of the pizza (the crust) absorbs moisture and becomes limp.

Pizza/food loses heat by radiation, conduction, convection and current pizza boxes provide essentially no barrier to radiated heat loss and convection (hot air) loss.

Companies which provide home food delivery services are constantly seeking ways to improve the service, food quality and taste due to the competitive nature of the business. Insulated food and pizza delivery bags have been used for many years whereby warmed foods will retain a certain temperature level during delivery, depending on the transportation time and delivery route length, primarily by blocking conduction of heat through the use of a bulky thick insulating barrier.

Yet, despite the proliferation of so-called “delivery” and “take out” items and services, mechanisms for effectively transporting the prepared food from one location to another have changed little over the past several decades. Referring to a familiar example, this lack of innovation in the food transportation industry is readily apparent.

No item of food is delivered to more American homes in greater quantities than the pizza. As the business of pushing pizzas exceeds the 32 billion dollar mark annually in the United States alone, multitudes of both multi-national and local establishments vie for their “slice” of the action.

At it's very best, though, a pizza delivered to your door pales in comparison to the same pizza served at a pizzeria. Apart from the ambiance of the red-checkered tablecloth and the spectacle of dough-tossing, pizzeria pizza is far superior because it has not suffered delivery deterioration. (e.g. cold and soggy)

The industry standard delivery time, pizza-to-door, is 30 minutes. The journey begins when the fresh, crisp-crusted, bubbling-cheese delicacy is removed from the oven and placed flat in the bottom of a box. Typically, the box is of the square, brown cardboard variety and may have a circular piece of reinforcing cardboard under the pizza to bolster its bottom. Then, the pizza is cut with a circular or “wheel” cutter. The box is closed, stacked on other pizza boxes and, when delivered by pizzeria personnel, is sometimes placed in a re-usable cumbersome insulating bag. The delivery driver tosses the bag into a delivery vehicle and makes the appointed rounds., It is during this journey that delivery deterioration occurs. The deterioration may be worse when a customer self transports the pizza, since the customer will not have the benefit of an insulating bag which is bulky, unyielding, and not easily stored when not in use.

While previous devices are advantageous under certain circumstances, the need for a simple, inexpensive delivery/ transportation container for retaining a certain temperature level during delivery remains. From the foregoing it is apparent that a food packaging system is required that is low in cost yet ensures that food, after the time delay required for delivery, are still warm (or cold), without having become substantially soggy. Accordingly, there is a need for a food transportation container which will maintain the food in a freshly-cooked state (or a refrigerated state) during delivery of the food from its point of origin to its destination, or simply over an elapsed time period that will effectively maintain heat, that is lightweight, and can be effectively used by restaurants and consumers alike.

### SUMMARY

A lightweight, disposable, and sealable food transportation container having a radiant barrier and a convection barrier, comprising a reflective material and an airtight material for slowing the heat transfer of an object placed within the container by minimizing heat lost by radiation and convection.

A system for maintaining the heat of a take-out food item, the system includes a disposable and sealable food transportation container having a radiant barrier and a convection barrier, the container includes a reflective material and an airtight material for slowing the heat transfer of an object placed within the container by minimizing heat lost by radiation and convection.

A system for maintaining the heat of a take-out food item, the system includes a disposable and sealable food transportation container having an integral radiant barrier and a convection barrier, the container includes a reflective material and an airtight material for slowing the heat transfer of an object placed within the container by minimizing heat lost by radiation and convection.

A system for maintaining the heat of a take-out food item, the system includes a disposable and sealable food transportation container and an enclosure for surrounding the food item, the disposable container having a radiant barrier and a convection barrier, the container includes a reflective material and an airtight material for slowing the heat transfer of an object placed within the container by minimizing heat lost by radiation and convection. In another embodiment, the disposable container includes at least one vent opposite an opening to the container to allow venting of moist vapor escaping from a heated foot item outside of the container. The vents also facilitate disposal, folding, or rolling of the container to minimize its volume.

A lightweight, disposable, and sealable food transportation container having a radiant barrier and a convection barrier, comprising a reflective material and an airtight material for slowing the heat transfer of an object placed within the container by minimizing heat lost by radiation and convection.

A system for maintaining the heat of a take-out food item, the system includes a disposable and sealable food transportation container having, a radiant barrier and a convection barrier, the container includes a reflective material and an airtight material for slowing the heat transfer of an object placed within the container by minimizing heat lost by radiation and convection.

In addition, the material used for the container should also be flexible, thin, and light so that it can be easily folded or rolled up when desired. Lastly, it is preferred that the material be inexpensive so that it is disposable. The container is foldable and rollable to be enveloped in a receptacle smaller than about 6×6 inches in length and width, respectively, while having length and width dimensions of 24×21 inches and an overall thickness of about 1.8 mil (i.e., 0.0018 inches) when unfolded/unrolled. In this manner, a container having the above unfolded/unrolled dimensions can be stacked in an array similar to a pad of paper perforated at the top. FIG. 12 depicts perforations generally at 123 corresponding to a top of adhesive strip 122. Alternatively, a container may be folded and placed in a corresponding receptacle configured to be hung on a display facilitating storage thereof in a limited amount of space.

The above-described and other features and advantages of the present invention will be appreciated and understood by those skilled in the art from the following detailed description, drawings, and appended claims.

### BRIEF DESCRIPTION OF THE DRAWINGS

FIG. 1 is a perspective view of an exemplary embodiment of a food container having its lid in the open position to reveal the heated food product;

FIG. 2 is a perspective view of the food container seen in FIG. 3 having its lid closed and joined to the body portion of the food container;

FIG. 3 is top plan view of a food container before assembly showing phantom fold lines;

FIGS. 4-7 illustrate an alternative embodiment of the present invention;

FIG. 8 illustrates another alternative embodiment of the present invention;

FIGS. 9 and 10 illustrate yet another alternative embodiment of the present invention;

FIG. 11 is a cross-sectional view of an alternative embodiment of the present invention;

FIG. 12 is a front elevation view of an unfolded/unrolled thermal bag having vent apertures opposite an opening to the bag in accordance with an alternative embodiment of the present invention;

FIG. 13 is a side elevation view of the bag of FIG. 12;

FIG. 14 is perspective view of the thermal bag of FIGS. 12 and 13 folded up;

FIG. 15 is front elevation view of the folded bag of FIG. 14 disposed in a receptacle configured to be hung on a display in accordance with an alternative embodiment of the present invention;

FIG. 16 is a front elevation view of a counter/shelf tree display having the bag and receptacle of FIG. 15 hanging therefrom, FIG. 16 also illustrates a hanging card display in phantom in accordance with an alternative embodiment of the present invention;

FIG. 17 is a perspective view of the thermal bag of FIGS. 12 and 13 rolled up in accordance with an alternative embodiment of the present invention; and

FIG. 18 is perspective view of the rolled up bag of FIG. 17 disposed in a receptacle configured to be hung on the tree or card of FIG. 16 in accordance with an alternative embodiment of the present invention.

### DETAILED DESCRIPTION

This disclosure relates to packages, and is more particularly directed to packages for take out and/or delivery of pizzas, Chinese food, fast food hamburgers, dessert pies, and the like. The disclosure is more particularly concerned with a thermally insulated disposable container for pizzas or other food items to be served hot (or cold), the container being configured with a radiant barrier, and a convection barrier.

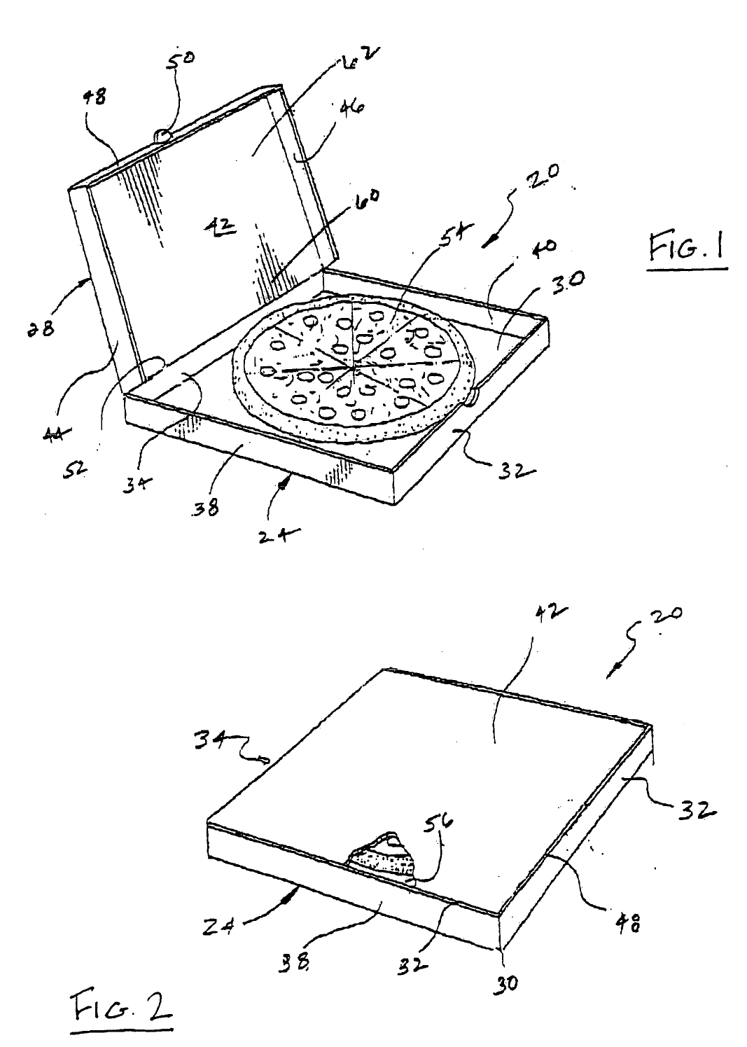

Referring to FIGS. 1 and 2, food container 20 includes a rectangular body portion 24 provided with a hinged lid 28, both of which are made of cardboard. The body portion 24 of the food container 20 includes a rectangular base section 30 integrally formed with upstanding front and rear walls 32 and 34, respectively, and a pair of laterally spaced upstanding side walls 38 and 40. The lid 28 has a rectangular top section 42 integrally formed with a pair downward depending laterally spaced side walls 44 and 46 and a front wall 48. A centrally located tab 50 is optionally cut out of the front wall 48 and is used to facilitate opening and closing of the lid 28. In addition, the lid 28 is hingedly connected to the rear wall 34 of the body portion 24 of the food container 20 at a score line 52 extending the length of the rear wall 34. Accordingly, the lid 28 is adapted to be folded downwardly about the score line 52 to a closed position wherein the side walls 44 and 46 and the front wall 48 of the lid 28 are located, as seen in FIG. 2, within the confines of the body portion 24 adjacent the side walls 38 and 40 and front wall 32. Food containers of this type are typically used for accommodating a heated pizza 54 as shown in FIG. 1. Once the lid 28 is closed, the hot pizza 54 is located in a closed rectangular chamber 56, the inner air of which becomes heated due to the heat loss of the pizza 54. The insulating properties of the cardboard, although limited to some extent, serve to prevent the heat in the chamber 56 from being rapidly dissipated. Various pizza companies as well as various “Mom and Pop” stores utilize food containers of the above-described type for holding a heated pizza.

In an exemplary embodiment, a radiant barrier 60 is attached to at least an inside or outside portion 62 of rectangular top section 42 for reflecting heat in chamber 56 back towards the pizza 54, thus helping to retain the temperature level of the pizza and reduce dissipation of the heat from the rectangular top section 42 of food container 20.

Radiant barrier 60 provides a thin, integrated reflection/insulator that is integrated into the box. In one embodiment, barrier 60 is Aluminum.

Radiant barrier 60 works by reducing the heat transfer by thermal radiation across the air space in chamber 56 between the top of pizza 54 and the inside portion 62 of rectangular top section 42. Radiant barrier 60 has a reflective surface that faces the open air in chamber 56 and the top of pizza 54.

Heat travels from a warm area to a cool area by a combination of conduction, convection, and radiation. Heat flows by conduction from a hotter material to a colder material when the two materials touch. Heat transfer by convection occurs when a liquid or gas is heated, becomes less dense, and rises. Radiant heat travels in a straight line away from the hot surface and heats anything solid as the wave of energy hits the solid. Since most of the heat transfer from pizza 54 is emitted from the top where the sauce and cheese are not insulated by the crust, an exemplary embodiment comprises radiant barrier 60 depending from at least an inside portion 62 of rectangular top section 42 that is directly above pizza 54.

Conventional insulation traps still air within the insulation, and hence also reduces the heat transfer by air movement (convection). The insulation fibers or particles also block radiation heat transfer through the space occupied by the insulation; however, having insulation on top of a pizza is undesirable for obvious reasons.

Radiant barrier 60 comprises a thin sheet or coating of a highly reflective material applied to a substrate (i.e., the cardboard that makes up rectangular top section 42 in FIG. 1.

In an exemplary embodiment, radiant barrier 60 is a metallized polymer applied to a portion of the inner or outer surface of container 20. In an alternative embodiment, radiant barrier is applied to substantially the entire inside or outside portion 62 of food container 20.

In an alternative embodiment, the radiant barrier is integrated into the box or the box is formed from a metalized cardboard. In this embodiment the metalized cardboard is preferably 24/1000 of an inch. Of course, and as applications may require the metallized cardboard can be greater or less than 24/1000 of an inch.

In practicing the present disclosure and using the pizza 54 as an example of a food product, the pizza 54 is initially baked and removed from the oven and placed on a cutting board. While on the cutting board, the pizza 54 is at a temperature of approximately 200 degrees Fahrenheit. The pizza 54 is then pre-cut into pie-shaped pieces and immediately placed within the food container 20 as seen in FIG. 1 after which the lid 28 is closed. Once the lid 28 is closed, some of the heat from the hot pizza will be transferred to the air within the chamber 56 and as well as to the food container 20 in its entirety by a combination of convection and conduction. Most of the heat from the pizza 54 radiates from the top of a pizza in a straight line away from the hot sauce surface because the sauce topping has a higher emissivity than the surrounding crust and therefore a greater emitted radiation. The emitted radiation contacts the radiant barrier 60 lining the lid 42 and radiates the heat back towards the pizza topping, thus aiding in heat retention.

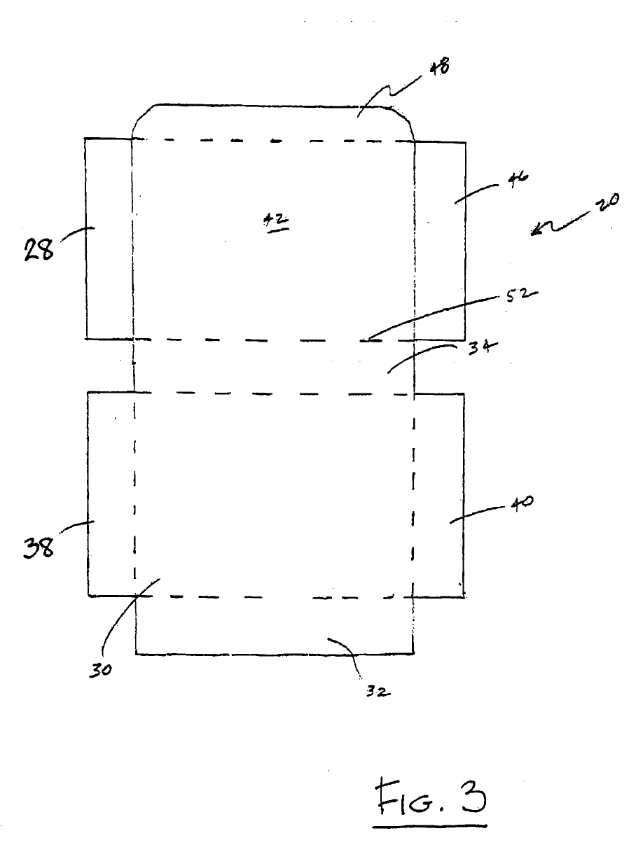

Referring now to FIG. 3, an alternative embodiment of a food container 20 is shown before assembly into a box structure. In an exemplary embodiment, the radiant barrier 60 is applied to substantially the entire inside or outside portion of food container 20. The above-described embodiments are also suitable for packaging hamburgers, hot grinders, and the like when the food container is configured to contain such foods.

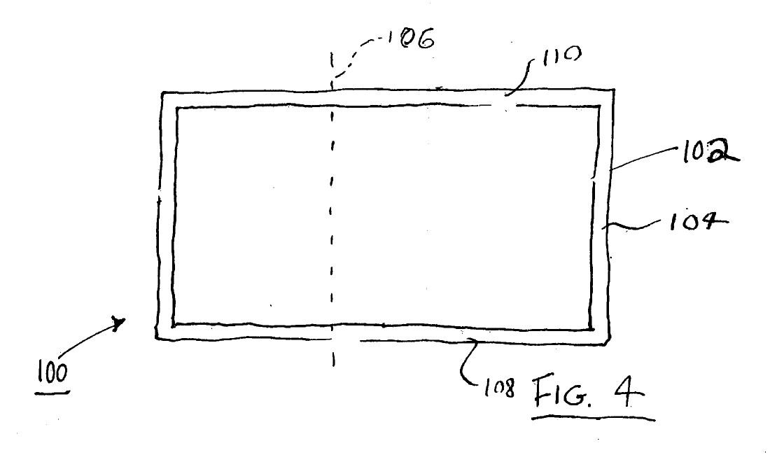

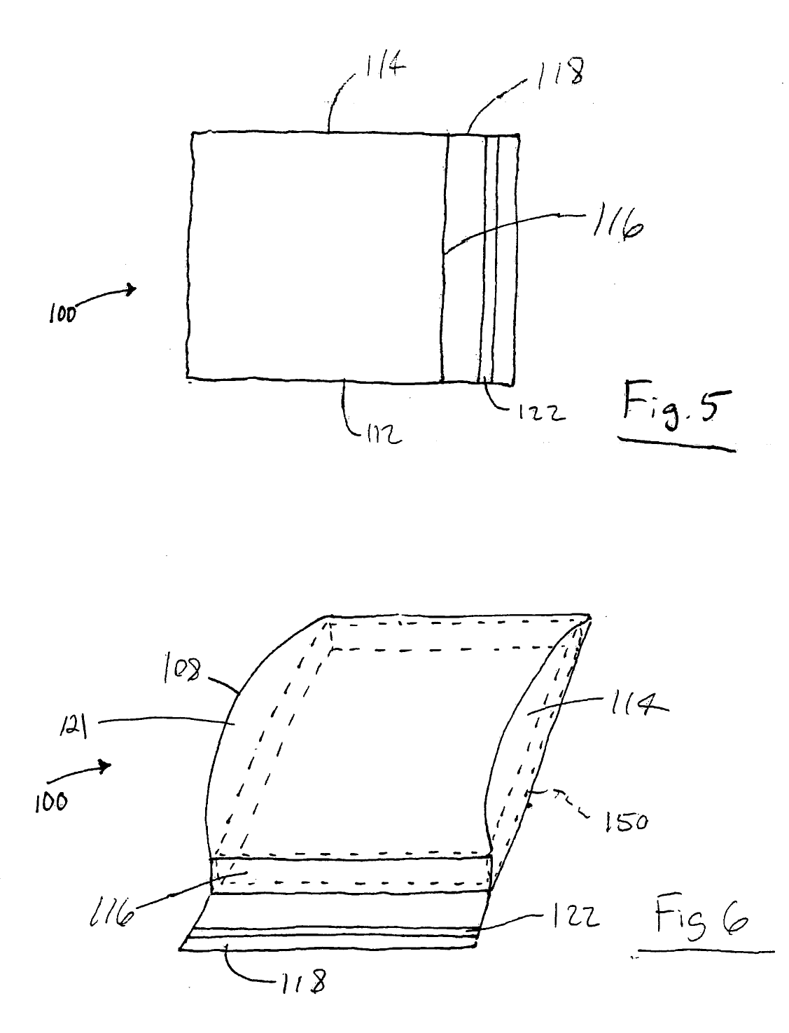

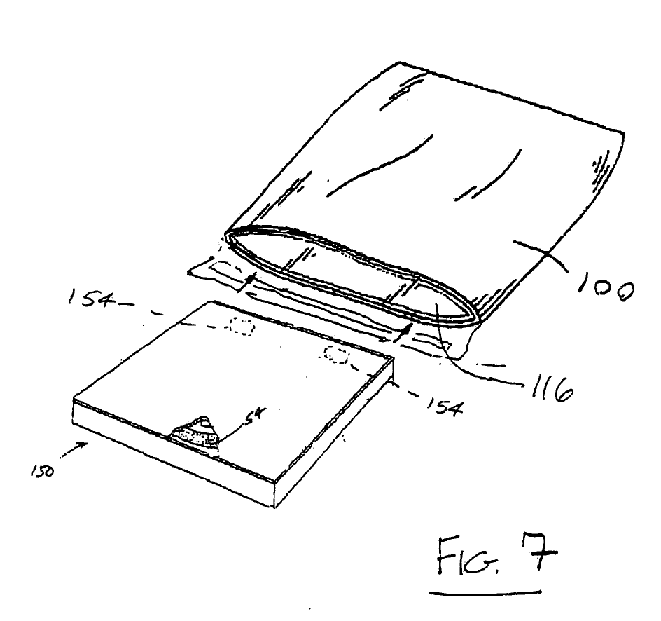

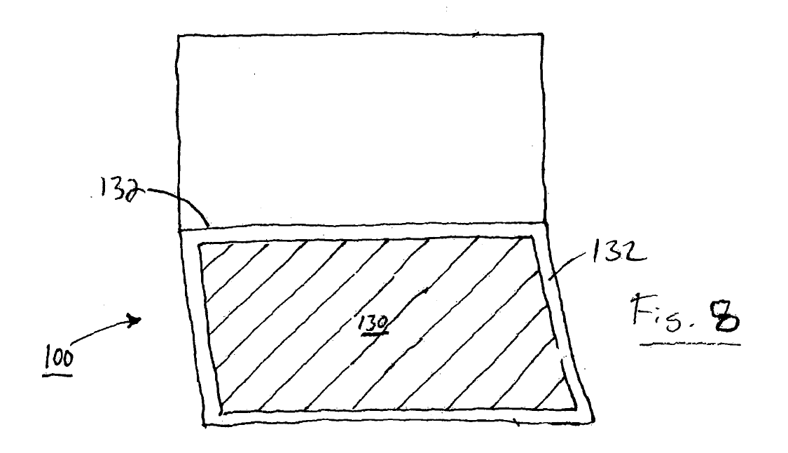

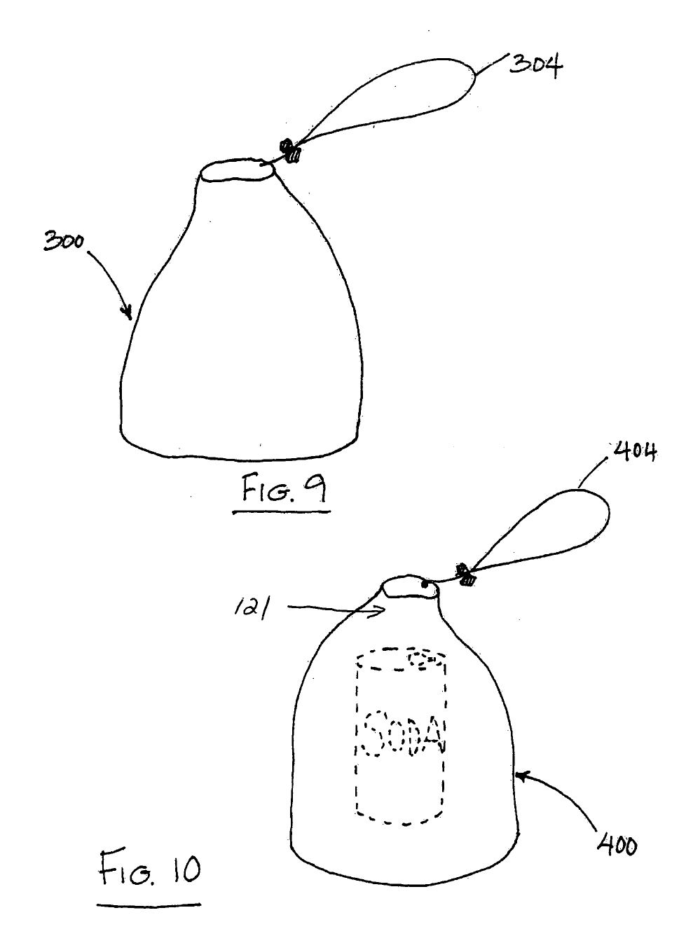

Turning now to FIGS. 4-7, another exemplary embodiment of a food container 100 is shown. FIG. 4 depicts a disassembled food container 100 having a radiant barrier sheet 102 comprising of a thin rectangular sheet of metalized oriented polyethylene. In an exemplary embodiment, the metalized oriented polyethylene has a thickness of about 0.00125 inches or 1.5 mm. Of course, is contemplated that the thickness of sheet 102 may be greater than or smaller than 0.00125 inches. Sheet 102 has the metalized layer on one side of sheet 102 while the other side is the polymer material from which sheet 102 is formed.

As an alternative, sheet 102 is a metalized polyethylene of approximately 1.25 mm or 0.00125. Of course, this thickness may also vary. As yet another alternative, sheet 102 is polypropylene, polyester, or polyethylene material with sufficient optical densities to act as potent reflective and convection barriers.

Container 100 provides a light-weight disposable container that has sufficient optical and reflective densities that will retain the heat and/or cold qualities of a food product inserted therein.

In one embodiment, container 100 is constructed out a thin polymer material that has an integral convection and reflective barrier (e.g. metalized oriented polyethylene). The thin and light-weight material of container 100 makes it ideal for use as a disposable food container. As will be discussed herein, container provides an air-tight enclosure with optimum heat retention characteristics and is convenient for disposable usage. In addition, and when the container is no longer needed the user simply tears the container to open it as it is constructed out of a thin material.

Moreover, and since the container is used for food products it is desirable to have it be disposable. Of course, what is meant by disposable means that it is economically feasible to dispose of the container, as opposed to just a capability thereof and matter of choice.

It is noted that in one embodiment radiant barrier 102 is provided with a non-metalized periphery 104 to aid in the assembly of container 100. Alternatively, the entire sheet 102 can have a metalized layer or coating. During assembly sheet 102 is folded about line 106 and the non-metalized periphery is sealed at sides 108 and 110 to define the enclosure illustrated in FIG. 5.

FIG. 5 shows a completed food container 100 that has seams 112 and 114 sealed and an opening 116 to provide a bag or envelope to place food in for delivery. Seams 112 and 114 are formed by the melting of the non-metalized portions of the polymer sheet or alternatively by an adhesive attachment of the same.

A flap portion 118, as in an envelope, for closing the food container is formed by folding sheet 102 at an asymmetrical folding line such as line 106 in FIG. 4. Thus, one half of folded sheet 102 is longer than the other half.

More specifically, flap portion 118 is a length that one half of sheet 102 that exceeds the other half when sheet 102 is folded about line 120. Flap portion 118 further includes an adhesive strip 122 with a peel off covering (e.g., peel off type used on envelopes) for adhering flap portion 118 to a portion of container 100 after an item has been inserted into container 100. Flap portion 118 is sufficiently long enough to provide enough material to seal container 100 after an item such as a pizza box has been inserted inside and provide adequate headspace 121 (FIGS. 6 and 10) and to allow venting through vents or openings 154 (See FIG. 7) in the pizza box if so equipped.

Due to its light-weight configuration container 100, through the use of flap portion 118 and its complimentary adhesive strip allows the sealed configuration of container 100 to be varied. For example, and in the case when a small item is placed in container 100 (e.g. a single slice of pizza) the user simply folds container 100 until the enclosed item is snugly encased and then the covering of the adhesive strip is removed and the container is sealed.

FIGS. 6 and 7 illustrate container 100 in an assembled state and being configured to accommodate a box carton in opening 116. In exemplary embodiment, container 100 has the following dimensions (24″×21″) in order to accommodate a standard size pizza box. Of course, the dimensions of container 100 may vary to accommodate objects of varying sizes.

Opening 116 is configured for easy placement of a complementary configured box (e.g., a pizza box) within food container 100. Due to the flexible nature of sheet 102, container 100 is easily folded and provides a flat configuration for storage. Thus, numerous containers can be easily stored for use in restaurant applications.

Current “pizza bags”, (e.g., delivery bags) are primarily insulators and by necessity, they must be thick and cumbersome. In accordance with an exemplary embodiment of the present invention and by blocking convection and radiation losses the materials for the bags or container 100 can be constructed out of much thinner, lighter, and less costly materials which are economically feasible to allow disposable thereof. Alternatively, the bags or container 100 can be refolded or rerolled and stored for reuse at a later time.

Current “pizza bags”, (e.g., delivery bags) and all other thermal bags are of such size and composition as to not allow them to be folded or rolled into a small enough package to allow the consumer to most efficiently carry them and thus use them, as well as not allowing the vendor of hot or cold food items to efficiently and effectively store them or present them to the public if they have limited shelf space (e.g., a pizza parlor).

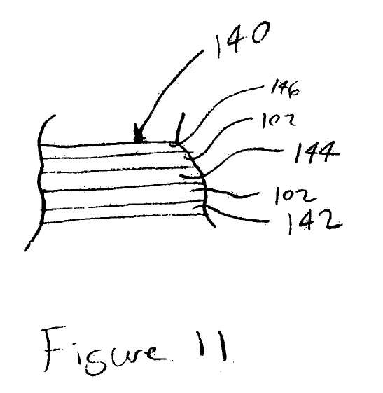

Referring now to FIGS. 12-18, an exemplary embodiment of a 24 inches ×21 inches thermal bag is illustrated generally at 200. Although the thermal bag of FIGS. 12 and 13 are described having dimensions W×L equal to 24 inches ×21 inches, other dimensions (W×L) are contemplated suitable to the desired end purpose. Thermal bag 200 is thin enough to allow it to be folded and disposed in a receptacle 202 having a hanging element 208. Hanging element 208 is an aperture 208 configured in receptacle 202 for hanging the receptacle on a display (see FIG. 16). Thermal bag when folded or rolled has W×L dimensions of 6 inches ×6 inches or less. The W×L dimensions include, but are not limited to 5×5, 4×4, 3×3, or 2×2. The most desirable W ×L dimensions include 2×2 having a thickness T of ¾ inches or less. It will be recognized that thermal bag 200 can be folded to any fractional size within the limits set forth above.

Referring again to FIGS. 12 and 13, the overall thickness of thermal bag 200 (e.g., including both sides defining thermal bag 200) is about 1.8 mil (i.e., 0.0018 inches). In an exemplary embodiment, bag 200 includes at least one vent 204 disposed at an opposite end of an opening 206 thereto. FIGS. 12 and 13 depict a pair of vents 204 disposed at the bottom of the bag at opposing corners thereof. Vents 204 facilitate removal of moist vapor escaping from a heated food item (e.g., vented pizza box). More specifically, vents 204 remove the moist heated vapor outside of the bag 200 limiting condensation thereof when colder ambient air causes condensation of the heated moist air to condense and saturate the pizza box, for example. As it is well recognized that a soggy pizza box is not desirable, but a hot pizza is. Therefore, vents 204 limit such condensation by allowing at least a portion of the moist vapor to escape from the bag via vents 204. During manufacturing of bag 200, a venting system includes a pair of vents 204 that are configured by leaving one inch or less of the bag corners unsealed during the manufacturing process.

Referring now to FIGS. 14-18, thermal bag 200 can be stored in a small efficient space. In turn, a consumer can more easily carry thermal bag 200 in a pocket or purse thus making it more likely that the consumer will have bag 200 when they need it. Likewise, the vendor of hot or cold food items often has limited shelf space for a non-foldable thermal bag. The current bags on the market and described in the prior art by their nature take up more space than thermal bag 200 disclosed herein. The thermal bags of the prior art rely on insulating inserts, or thick material to allow them to properly function. Thermal bag 200 in exemplary embodiments described herein allow for acceptable thermal protection, and yet can be folded or rolled to a small package as noted above. The vendor in turn, can sell an array of individually packaged bags 200 which take up substantially less counter or shelf space than a comparable 24 inch ×21 inch bag compared to an exemplary bag 200 having W×L dimensions between about (2 inches ×2 inches) and about (6 inches ×6 inches). In addition, the vendor can stack the bags as an array similar to a note pad of paper that is perforated at the top. This allows the vendor to use a bag 200 and tear it off exposing the next bag 200 ready for food or beverages to be placed therein. In this fashion, the vendor can stack approximately 500 bags in a space occupying about 24 inches ×21 inches ×1 inch (i.e., 500 bags having a combined thickness of one inch). By nature of the prior art design, there is no way for the prior art bags to be stacked in a similar fashion occupying such a limited space.

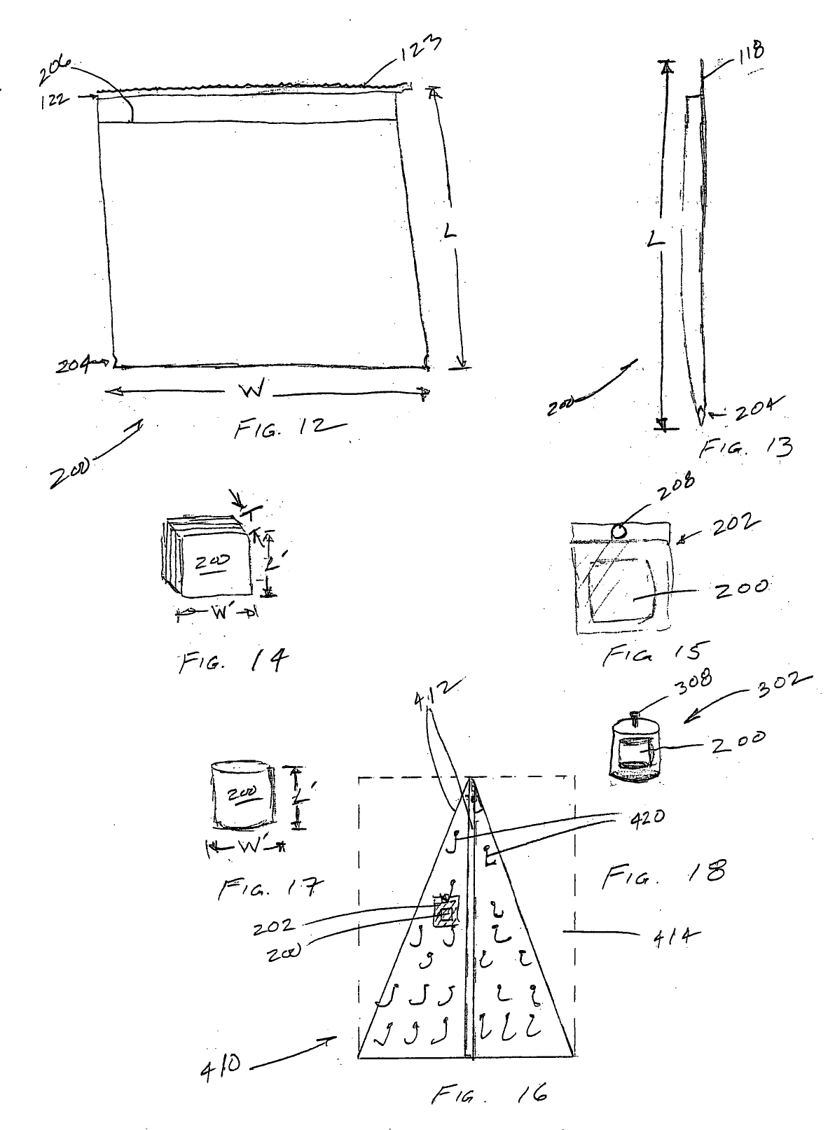

FIG. 17 illustrates thermal bag 200 rolled up in an alternative embodiment. In this embodiment, bag 200 is folded along a length L to a dimension of L′ being between about 2 inches and about 6 inches and then rolled up along an axis corresponding to W. FIG. 18 illustrates the rolled up bag of FIG. 17 disposed in a receptacle 302 having a hanging element 308 depending therefrom for hanging on a display (see FIG. 16).

FIG. 16 is a display 410 configured to display a plurality of bags 200 in a limited amount of space. Display 410 includes a “tree” comprising a pair of intersecting triangles 412 or planar rectangular sheet 414 shown with phantom lines, for example. In either case, display 410 may be fabricated of cardboard or any other suitable material. However, other configurations are contemplated for display 410 and are not limited to the tree and planar sheet configurations of FIG. 16. Display 410 includes a plurality of hooks 420 configured to hang receptacles 202, 302 via respective hanging elements 208, 308. In an exemplary embodiment as depicted, the tree configuration display 410 may stand between about 12 inches high to about 18 inches high on countertop or shelf. In this manner, between about 15 and about 20 bags 200 may be disposed on display 410.

In a quantitative test utilizing a pizza bag (e.g., food container 100, 200) constructed in accordance with an exemplary embodiment of the present invention, one boxed pizza using a standard pizza box was placed within the sealed container 100 and another boxed pizza was left standing alone, both in a room at room temperature, after 17 minutes elapsed, the temperature of the pizza placed in the pizza bag was 142.5° Fahrenheit and the unbagged pizza was 123.4° Fahrenheit. Container 100 provided a pizza that was 15.5% hotter. In addition, four blinded subjects accurately picked the bagged pizza as hotter compared to the un-bagged pizza.

In addition, while the pizza is placed within container 100 moisture from the steaming pizza as well as moisture from the standard cardboard box is condensated onto the outside of the box. This important feature allows the moisture to vent out of the inside of pizza box 150 and harmlessly condensate on the exterior surface of the pizza box preventing the pizza from becoming soggy.

For example, and referring now to FIGS. 6 and 7, a conventional pizza box 150, with the pizza 54 in place, is inserted into container 100. The container 100 is configured and dimensioned so as to contain a complementary sized pizza box 150 as well as expand (FIG. 6) due to heat from pizza 54. After insertion of pizza box 150 into container 100, pizza box 150 is then sealed within container 100 through the use of flap 118 and adhesive 122.

In this configuration, openings 154 provide a ventilation outlet or outlets to permit escape of moisture that dissipates from the heated pizza 54, thus diminishing the tendency of such pizzas to become soggy, while providing a radiant barrier to reflect heat energy back towards the pizza 54. In such a configuration, the heat retention by the pizza is enhanced while the amount of moisture dissipated onto the pizza is limited. Accordingly, the likelihood of a soggy pizza due to moisture is reduced and/or negated, whilst simultaneously maintaining the heat of the pizza/food.

Accordingly, and through the use of container 100, the heated air travels from the internal cavity of pizza box 150 travels through vent openings 154 and is entrained within the cavity defined by container 100. In addition, and through this airflow moisture from pizza 54 as well as the moisture of the cardboard material comprising box 150 is harmlessly vented out of pizza box 150 and ultimately condensated on the exterior surface of the same.

In yet another alternative, container 100 is used in combination with the embodiment of FIGS. 1-3 further enhancing the heat retention qualities of the present invention.

Further combinations are also contemplated including but not limited to pizza box 150 being constructed with radiant barrier 60 on either the inside or outside portion of the pizza box. In addition, it is also contemplated that radiant barrier 60 may be positioned on both the inner and outer portions of the pizza box which is then inserted within container 100, effectively maximizing heat retention utilizing a bag and box system.

In addition, a pizza box construction in accordance the embodiments of FIGS. 1-3 is contemplated for use with container 100.

Referring now to FIG. 8, yet another alternative embodiment is illustrated, here sheet 102 is provided with a thin layer of insulative material 130 configured and dimensioned to be about half the size of sheet 102. Insulative material 130 is disposed on a first half 132 of radiant sheet 102.

The other half of sheet 102 is folded over insulative material 130 at fold 132 and the two sides are sealed essentially providing a three-ply sheet material. This three-ply sheet material is then folded as illustrated in FIG. 4 to provide container 100.

Alternatively, and referring now to FIGS. 4-8 and 11, sheet 102 is folded over itself once and then again and the two sides are sealed essentially providing a three-ply sheet material 140, comprising a metal reflective layer 142 as a radiant barrier facing the food, a middle convection barrier 144 an insulating layer, and an outer metal reflective layer 146 facing the outside environment that can be water resistant to protect the food from outside elements (e.g., rain) and contain the food in the food container in the event of a the food spill. For example, and when sheet 102 is folded over itself layers 142 and 146 are provided by the metalized polymer of sheet 102 and insulative layer 144 is provided by the air entrained between sheet 102 as it is folder over on itself.

Thus, and referring now to FIG. 11 a Trilaminar design including an inner reflective layer which can be perforated, a middle layer or convection barrier and an outer layer (reflective) provide the material for container 100.

In yet another alternative, the surface of sheet 102 comprising layer 146 is configured to have a higher concentration of metalized polymer.

In addition, the material used for the container should also be flexible, thin, and light so that it can be easily folded up when desired. Lastly, it is preferred that the material be inexpensive so that it is disposable.

Additionally, the material for container is also contemplated to be capable of having indicia printed thereon. The indicia may included advertising materials or trademarks, etc.

Referring now to FIG. 9, an alternative embodiment 300 of container 100 is shown with a drawstring closure 304 that considerably reduces the rate of heat loss from a packaged pizza, Chinese take-out, or the like, stored therein by (reducing the size of the opening from which the heat energy of the packaged food can escape to a lower-temperature outside environment) mechanisms previously described (radiating heat and blocking convection currents).

FIG. 10 illustrates another alternative embodiment of a food container shown generally at 400 for considerably reducing the heat energy absorbed by a cold food stored therein by reducing the amount of heat energy from a higher-temperature outside environment from reaching the cold food stored within bag 400 (i.e., cold soda can). One embodiment of bag 400 is bag 300 turned inside out, wherein the reflective layer is facing the higher-temperature outside environment providing a radiant barrier for the higher-temperature heat energy and thereby reducing the emissivity of bag 400 to emit the heat energy to the cold food stored therein. In quantitative tests with bag 400, two cold soda beverage cans were taken from a refrigerator at 45° Fahrenheit. One soda can was placed in bag 400 and closed via drawstring 404, the other soda can was left alone in the same room at room temperature. After 45 minutes elapsed, the bagged soda can was at a 48° Fahrenheit and the unbagged soda can was at a temperature of 51.6° Fahrenheit. It will be appreciated that in a warmer outside climate, the differential is significantly larger.

Current “pizza bags”; (e.g., delivery bags) are primarily insulators and by necessity, they must be thick and cumbersome. In accordance with an exemplary embodiment of the present invention and by blocking convection and radiation losses the materials for the bags or container 100 can be constructed out of much thinner, lighter, and less costly materials which make them economically feasible for disposable.

As a result of the present disclosure, an economical and disposable heat maintaining food delivery container is provided. Through its combination of components, embodiments described herein meet both the customer's desire to receive delivered pizzas/food which are still highly palatable, in terms of warmth and crispness, and the pizza supplier's desire to minimize packaging costs. On the basis of the foregoing it will be seen that this disclosure has been described which will allow pizza to be delivered to consumers in a low cost format, while providing for the preservation of the quality of the product up to the time of delivery. Likewise, an economical and disposable bag is provided for keeping food cold longer.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A food transportation container, comprising:
a deformable container configured for limiting heat energy transfer of a food item therein, the deformable container defined by a pair of opposing sides having a combined thickness of about 0.0018 inches, the deformable container having a degree of deformability of being at least one of folded and rolled up into a width×length dimension of between about 2 inches ×2 inches and about 6 inches ×6 inches;
an opening on one side of the container for inserting and removing said food item;
an integral radiant barrier configured to provide a barrier to convection and radiation of heat, said barrier configured to limit heat transfer within the container thus limiting heat energy transfer to or from said food item having a top and a base, said food item including at least one of a beverage and food disposed in the container; and
a flap portion depending from said container proximate to said opening, said flap portion being configured and dimensioned to cover and seal said opening.

2. The food transportation container of claim 1, wherein the deformable container is at least one of rolled and folded up and disposed in a receptacle having a width and length dimension of between about 2 inches ×2 inches and about 6 inches ×6 inches.

3. The food container of claim 2, wherein the receptacle is hung on a display configured to hang a plurality of receptacles.

4. The food container of claim 3, wherein the display is receptive to displaying the plurality of receptacles on at least one of a wall, a shelf, and a countertop.

5. The food transportation container of claim 1, wherein the deformable container is stacked in an array with a plurality of deformable containers having a combined thickness of about one inch.

6. The food transportation container of claim 5, wherein the plurality of deformable container includes about 500 bags.

7. The food transportation container of claim 5, wherein each of the plurality of deformable container in the array is dispensed by tearing said each at a corresponding perforation.

8. The food transportation container of claim 7, wherein the perforation is disposed on the flap portion.

9. The food transportation container of claim 1, wherein the degree of deformability allows the container to have a thickness of about ¾ inch when the container is folded in the width×length dimension of 2 inches ×2 inches.

10. The food transportation container of claim 1, wherein the degree of deformability allows the container to conform to the food item and create a headspace, the headspace allowing moist vapor to escape from the food item.

11. The food transportation item of claim 10, wherein the container includes at least one aperture opposite the opening on the one side of the container for inserting and removing said food item, the aperture allowing the moist vapor to escape from the container limiting condensation thereof onto the food item.

12. The food transportation item of claim 11, wherein the at least one aperture includes a pair of apertures, each aperture proximate a corner of the container opposite the opening.

13. A disposable food container comprising:
an enveloping deformable bag configured for limiting heat energy transfer of a food item therein, the deformable bag defined by a pair of opposing sides having a combined thickness of about 0.0018 inches, the deformable bag having a degree of deformability of being at least one of folded and rolled up into a width×length dimension of between about 2 inches ×2 inches and about 6 inches ×6 inches;
an aperture on one side of the bag for inserting and removing said food item;
an integral thermal convection barrier;
an integral radiant barrier configured to provide a barrier to convection and radiation of heat, said barrier configured to limit heat energy transfer within the bag thus limiting heat transfer to from said food item having a top and a base, said food item including at least one of a beverage and food disposed in the bag; and
a flap portion depending away from said bag proximate to said aperture, said flap portion being configured and dimensioned to cover and seal said aperture.

14. The disposable food container of claim 13, wherein said radiant barrier is a metallized polymer, said container being constructed out of said metallized polymer.

15. The disposable food container of claim 14, wherein said metallized polymer eliminates a bulky insulative layer facilitating at least one of disposal, rolling up, and folding thereof.

16. The disposable food container of claim 15, wherein said metallized polymer is selected from the group comprising polymers, polypropylene, polyester, or polyethylene.

17. The disposable food container of claim 14, wherein said metallized polymer is one of a metallized polyethylene and a metallized oriented polypropylene.

18. The disposable food container of claim 13, wherein said radiant barrier includes a highly reflective surface.
